(19) United States
(12) Patent Application Publication
(10) Pub. No.: US 2025/0313670 A1
(43) Pub. Date: Oct. 9, 2025

(54) POLYSILOXANE POLYMER COMPOSITION AND THE PREPARATION METHOD THEREOF

(71) Applicant: MOMENTIVE PERFORMANCE MATERIALS INC., Niskayuna, NY (US)

(72) Inventors: Zhipeng ZHENG, Pudong New Area Shanghai (CN); Roland WAGNER, Leverkusen (DE); Susan ZOU, Pudong New Area Shanghai (CN); Mark LEATHERMAN, Tarrytown, NY (US)

(21) Appl. No.: 18/866,346

(22) PCT Filed: Jun. 2, 2023
(86) PCT No.: PCT/CN2023/098027

§ 371 Date: Nov. 15, 2024

(30) Foreign Application Priority Data
Jun. 2, 2022 (CN) 202210626204.0

(51) Int. Cl. C08G 77/388; C08G 77/46

(52) U.S. Cl. CPC C08G 77/388; C08G 77/46

(57) ABSTRACT

The present invention relates to polysiloxane polymer compositions and methods for their preparation. The polysiloxane polymer compositions of the invention advantageously have low levels of small molecules of cyclic siloxane, such as octamethylcyclotetrasiloxane (D4).

### FIELD OF THE APPLICATION

The invention relates to the field of polysiloxane polymer and the composition comprising such polysiloxane polymer, especially polysiloxane polymer containing quaternary ammonium group, the invention also relates to a preparation method for the composition comprising polysiloxane polymer.

### BACKGROUND OF THE APPLICATION

Polysiloxane polymer is widely used in various applications. For example, such polymer is often used in fabric finishing agent or softener. In such type of polysiloxane polymer, hydrophobic polysiloxane moiety, quaternary ammonium moiety, and hydrophilic moiety are usually included. These three moieties impart polysiloxane polymer with desired properties. In prior art, the preparation of polysiloxane polymer involves a step of reacting polysiloxane moiety, quaternization moiety and hydrophilic moiety in the presence of protonation agent and quaternization. The protonation agents are added in stoichiometiric amounts during the quaternization reaction.

Since polysiloxane polymer is widely used, it also brings about corresponding environmental concerns. During the storage and preparation of polysiloxane polymer, especially the preparation process of the prior art, large amount of substance that is not environment friendly is generated, for example octamethylcyclotetrasiloxane, referred to as D4, decamethylcyclopentasiloxane, referred to as D5, and dodecamethylcyclohexasiloxane, referred to as D6.

Targeting the negative impact of substance such as D4 on the environment, European Chemicals Agency (ECHA) lists D4 as Substance of Very High Concern (SVHC), and set requirements for its content, aiming at reducing D4, D5 or D6 in polysiloxane polymer or in the composition containing them to a low level, for example below 1000 ppm.

Quaternized polysiloxane polymer products synthesized according to prior art protocols do not meet the requirement of European Chemicals Agency. For example, commercially available polysiloxane polymer comprising quaternary ammonium moiety respectively contain D4, D5 and D6 contents above 1000 ppm.

A reliable protocol for a long term reduction of the D4, D5 and D6 level below 1000 ppm is not described in the prior art.

Therefore, there is a need for polysiloxane polymer composition with a long term low D4, D5 and/or D6 level, addressing the increasing concerns of the public for the environment.

### BRIEF SUMMARY OF THE INVENTION

Regarding the above technical problem, the invention provides polysiloxane polymer composition that could meet the requirement set by European Chemicals Agency regarding the content of D4, D5 and D6, and provides a preparation method for obtaining such polysiloxane polymer composition. The inventor found that by performing the reaction for synthesizing polysiloxane polymer in the presence of strong acid having a pKa of no greater than 3.0, the obtained polysiloxane polymer composition has low D4, D5, D6 (collectively referred to as Dn hereinafter) contents. In addition, inventor found that, regardless if the strong acid having a pKa of no greater than 3.0 is used or not during the reaction for synthesizing polysiloxane polymer, the addition of strong acid having a pKa of no greater than 3.0 after the synthesis reaction could reduce the Dn content in the obtained polysiloxane polymer composition, and reduce the generated Dn content during storage. Apparently, using strong acid having a pKa of no greater than 3.0 both during and after the synthesis reaction could optimally reduce Dn content. Consequently, the intention solves the technical problem regarding high Dn content in the prior art.

The invention includes the following embodiments.

According to one embodiment of the invention, the invention provides polysiloxane polymer composition, wherein said Polysiloxane polymer composition is a product obtained from a process comprising the following steps:
reaction of hydrophobic component (a) comprising polysiloxane backbone and quaternization component (b) comprising tertiary amine group in the presence of protonation component (p);
wherein the protonation component (p) comprises at least one protonation compound (c) having a pKa of greater than 3.0 and at least one protonation compound (d) having a pKa of no greater than 3.0, preferably no greater than 2.5, preferably no greater than 2.0, more preferably no greater than 1.5, most preferably no greater than 1.0, and wherein the molar ratio between all protonation compound (c) and all protonation compound (d) (ΣMol_{protonation compound (c)}/ΣMol_{protonation compound (d)}) ranges from 9:1 to 0.1:1, preferably from 9:1 to 0.2:1, more preferably from 5:1 to 0.2:1, even more preferably from 2:1 to 0.2:1, most preferably from 2:1 to 0.4:1, still more preferably from 2:1 to 1:1;
wherein said polysiloxane polymer comprises following repeating unit:

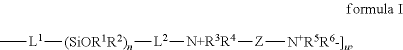

wherein u is from 2 to 100; L¹ and L² are the same or different, and are chosen from a covalent bond and a hydrocarbon chain having 1-20 carbon atoms optionally substituted with O, N or S atom, or substituted with groups containing O, N or S atom; R¹ and R² are the same or different and are chosen from an optionally substituted hydrocarbon chain having 1-20 carbon atoms, preferably methyl group, n is from 1 to 1000, preferably from 20 to 500, preferably from 40 to 450, more preferably from 50 to 200, even more preferably from 50 to 150; and
Z is a hydrocarbon chain containing 2-20 carbon atoms and optionally substituted with O, N or S atom, or substituted with groups containing O, N or S atom, preferably with OH group; R³, R⁴, R⁵ and R⁶ are the same or different and chosen from a hydrocarbon chain containing 1-20 carbon atoms,
or, said polysiloxane polymer comprises of repeating unit of formula I′:

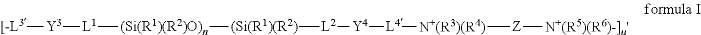

wherein n, u, L¹, L², R¹, R², R³, R⁴, R⁵, R⁶ and Z are defined as above,
Y³ and Y⁴ are the same or different and are respectively each independently chosen from O, N(R⁷) or S, R⁷═H or C₁-C₃ hydrocarbon group, for example C₁-C₃ alkyl group;
L^{3′} and L^{4′} are the same or different, and are chosen from covalent bond and hydrocarbon chain substituted by group(s) containing O, N or S atom, preferably OH, NH₂ or SH, and having 2-20 carbon atoms, preferably alkylene group having 2-6 carbon atoms, more preferably alkylene group having 3-4 carbon atoms; in particular, said OH, NH₂ or SH is derived from the ring opening reaction of oxygen heterocyclic ring having single oxygen atom, nitrogen heterocyclic ring having single nitrogen atom or sulfur heterocyclic ring having single sulfur atom (for example epoxy, aziridinyl or thioepoxy group) located at the end of the corresponding alkylene group of said hydrophobic component (a);
preferably, L¹ and L² are the same or different, and are respectively each independently chosen from alkylene group having 1-6 carbon atoms, in particular having 2, 3, 4 or 5 carbon atoms;
preferably, R³, R⁴, R⁵ and R⁶ each are independently alkyl group and Z is alkylene group, more preferably Z is a linear alkylene group comprising 2-8 carbon atoms for example butylene or hexylidene, and R³, R⁴, R⁵ and R⁶ are the same or different and are respectively each independently chosen from alkyl group containing 1-4 carbon atoms, for example R³, R⁴, R⁵ and R⁶ are all methyl groups;
said polysiloxane polymer composition also comprises counterions.

In the context of the invention, aziridinyl group and thioepoxy group are respectively the equivalents of epoxy group in which oxygen atom in epoxy group is substituted by nitrogen atom (or amine group) substituted and sulfur atom.

According to one embodiment of the invention, said Polysiloxane polymer composition is a product obtained from a process comprising the following steps:
reaction of hydrophobic component (a) comprising polysiloxane backbone and quaternization component (b) comprising tertiary amine group in the presence of protonation component (p); protonation component (p) comprises at least one protonation compound (c) having a pKa of greater than 3.0, and
protonation compound (d) is used during said reaction,
protonation compound (d) is added after said reaction, or
protonation compound (d) is used during said reaction and added after said reaction;
protonation compound (d) having a pKa of no greater than 3.0, preferably no greater than 2.5, preferably no greater than 2.0, more preferably no greater than 1.5, most preferably no greater than 1.0;
wherein said polysiloxane polymer comprises following repeating unit:

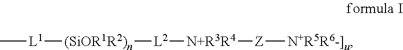

wherein u is from 2 to 100; L¹ and L² are the same or different, and are chosen from a covalent bond and a hydrocarbon chain having 1-20 carbon atoms optionally substituted with O, N or S atom, or substituted with groups containing O, N or S atom; R¹ and R² are the same or different and are chosen from an optionally substituted hydrocarbon chain having 1-20 carbon atoms, preferably methyl group, n is from 1 to 1000, preferably from 20 to 500, preferably from 40 to 450, more preferably from 50 to 200, even more preferably from 50 to 150; and
Z is a hydrocarbon chain containing 2-20 carbon atoms and optionally substituted with O, N or S atom, or substituted with groups containing O, N or S atom, preferably with OH group; R³, R⁴, R⁵ and R⁶ are the same or different and chosen from a hydrocarbon chain containing 1-20 carbon atoms,
or, said polysiloxane polymer comprises of repeating unit of formula I′:

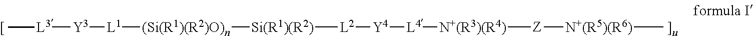

wherein n, u, L, U, R¹, R², R³, R⁴, R⁵, R⁶ and Z are defined as above,
Y³ and Y⁴ are the same or different and are respectively each independently chosen from O, N(R⁷) or S, R⁷═H or C₁-C₃ hydrocarbon group, for example C₁-C₃ alkyl group;
L^{3′} and L^{4′} are the same or different, and are chosen from covalent bond and hydrocarbon chain substituted by group(s) containing O, N or S atom, preferably OH, NH₂ or SH, and having 2-20 carbon atoms, preferably alkylene group having 2-6 carbon atoms, more preferably alkylene group having 3-4 carbon atoms; in particular, said OH, NH₂ or SH is derived from the ring opening reaction of oxygen heterocyclic ring having single oxygen atom, nitrogen heterocyclic ring having single nitrogen atom or sulfur heterocyclic ring having single sulfur atom (for example epoxy, aziridinyl or thioepoxy group) located at the end of the corresponding alkylene group of said hydrophobic component (a);
preferably, L¹ and L² are the same or different, and are respectively each independently chosen from alkylene group having 1-6 carbon atoms, in particular having 2, 3, 4 or 5 carbon atoms;
preferably, R³, R⁴, R⁵ and R⁶ each are independently alkyl group and Z is alkylene group, more preferably Z is a linear alkylene group comprising 2-8 carbon atoms for example butylene or hexylidene, and R³, R⁴, R⁵ and R⁶ are the same or different and are respectively each independently chosen from alkyl group containing 1-4 carbon atoms, for example R³, R⁴, R⁵ and R⁶ are all methyl groups;
said Polysiloxane polymer composition also comprises counterions.

According to one embodiment of the invention, polysiloxane polymer further comprises repeating unit of formula II [-L¹-(SiOR¹R²)ₙ-L²-Y^{1′}-E-Y^{2′}—],
wherein v is from 1 to 100, E is a covalent bond or a polyether moiety comprising one or more of the following repeating unit: -(ethylene oxide)ₓ-, -(propylene oxide)_{y}- or -(butylene oxide)_{z}-, x, y and z are the same or different, and
x=0 or 1-100, preferably 1-20, more preferably 1-10, even more preferably 1-5, most preferably 1, 2 and 3,
y=0 or 1-100, preferably 1-20, more preferably 1-10, even more preferably 1-5, most preferably 1, 2 and 3,
z=0 or 1-100, preferably 1-20, more preferably 1-10, even more preferably 1-5, most preferably 1, 2 and 3,
x+y+z=0-100, preferably 0 and 1-100, more preferably 1-20, even more preferably 1-10, most preferably 0, 1, 2, 3;
Y^{1′} and Y^{2′} comprise functional groups independently chosen from nitrogen-containing groups, oxygen-containing groups or sulfur-containing groups, preferably amine-containing groups, hydroxyl-containing groups or thiol-containing groups, more preferably amine-containing groups, most preferably secondary amine-containing, tertiary amine-containing groups, amine salts derived from secondary or tertiary amine containing groups, or quaternary ammonium-containing groups, at least one of Y^{1′} and Y^{2′} optionally contains hydrocarbon groups connecting their functional groups to E or to the other one of Y^{1′} and Y^{2′} and containing 1-20 carbon atoms,
or, polysiloxane polymer further comprises repeating unit of formula II′:

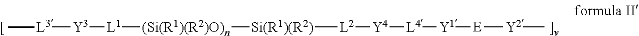

wherein n, v, L, L², R¹, R², E, Y^{1′}, Y^{2′}, L³′, Y³, Y⁴ and L^{4′} are defined as above,
preferably, at least one of Y^{1′} and Y^{2′} optionally contains hydrocarbon group connecting the above-mentioned functional group to E or to the other one of Y^{1′} and Y^{2′} and containing 1-20 carbon atoms, in particular alkylene group, for example linear or branched alkylene group containing 1-6 or 1-3 carbon atoms, and at least one of the above-mentioned functional group is optionally directly connected to E by covalent bond.

The above expression ‘-(ethylene oxide)ₓ-’ refers to the unit obtained from after ethylene oxide is polymerized.

According to one embodiment of the invention, hydrophobic component (a) contains structure of formula III:

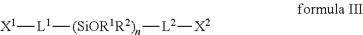

wherein L¹ and L² are the same or different and are chosen from a covalent bond and a hydrocarbon chain having 1-20 carbon atoms optionally substituted with 0, N or S atom, or substituted with groups containing 0, N or S atom; X¹ and X² groups are the same or different and are chosen from H, epoxy group or hydroxyl group, or derived from ethylene oxide, propylene oxide or butylene oxide, and when L¹ and L² are covalent bonds, X¹ and X² groups are H; R¹ and R² are the same or different and are chosen from an optionally substituted hydrocarbon chain containing 1-20 carbon atoms, preferably methyl group, n is from 1 to 1000, preferably from 20 to 500, preferably from 40 to 450, more preferably from 50 to 200, even more preferably from 50 to 150,
or, the hydrophobic component (a) contains a structure of formula III′:

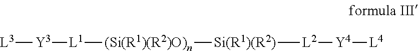

wherein, n, L¹, L², R¹, R², Y³ and Y⁴ are defined as above, L³ and L⁴ are the same or different and are hydrocarbon chain comprising oxygen heterocyclic ring having single oxygen atom, nitrogen heterocyclic ring having single nitrogen atom or sulfur heterocyclic ring having single sulfur atom (for example epoxy, aziridinyl or thioepoxy group), preferably oxygen heterocyclic ring having single oxygen atom, nitrogen heterocyclic ring having single nitrogen atom or sulfur heterocyclic ring having single sulfur atom (for example epoxy, aziridinyl or thioepoxy group) of from 3 to 5 membered ring and having 2-20 carbon atoms, preferably alkylene group having 2-6 carbon atoms, more preferably alkylene group having 3-4 carbon atoms; in particular, said oxygen heterocyclic ring having single oxygen atom, nitrogen heterocyclic ring having single nitrogen atom or sulfur heterocyclic ring having single sulfur atom (for example epoxy, aziridinyl or thioepoxy group) is located at the end of said alkylene group.

According to one embodiment of the invention, quaternization component (b) contains a structure of formula IV:

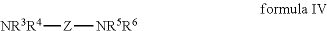

wherein Z is a linear, branched, or cyclic hydrocarbon moiety containing 2-20 carbon atoms and optionally substituted with 0, N or S atom, or substituted with groups containing 0, N or S atom, preferably with OH group; R³, R⁴, R⁵ and R⁶ are the same or different and are chosen from a hydrocarbon group containing 1-20 carbon atoms,
or, the quaternization component (b) contains structure of formula IV′:

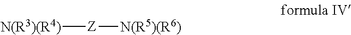

wherein, R³, R⁴, R⁵, R⁶ and Z are defined as above;
preferably, R³, R⁴, R⁵ and R⁶ each are independently alkyl group and Z is alkylene group, more preferably Z is a linear alkylene group comprising 2-8 carbon atoms for example butylene or hexylidene, and R³, R⁴, R⁵ and R⁶ are the same or different and are respectively each independently chosen from alkyl group containing 1-4 carbon atoms, for example R³, R⁴, R⁵ and R⁶ are all methyl groups.

According to one embodiment of the invention, hydrophilic component (e) is also present in said reaction, and hydrophilic component (e) contains a structure of formula V:

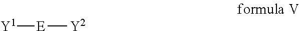

wherein the meaning of E is as defined above; Y¹ and Y² comprise functional groups independently chosen from nitrogen-containing groups, oxygen-containing groups or sulfur-containing groups, preferably amine-containing groups, hydroxyl-containing groups or thiol-containing groups, more preferably amine-containing groups, most preferably primary amine-containing or secondary amine-containing groups, at least one of Y¹ and Y² optionally contains hydrocarbon groups connecting their functional groups to E or to the other one of Y¹ and Y² and containing 1-20 carbon atoms,
or, the hydrophilic component (e) contains structure of formula V′:

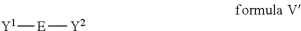

wherein Y¹, Y² and E are defined as above,
preferably, at least one of Y¹ and Y² optionally contains a hydrocarbon group connecting the above-mentioned functional group to E or to the other one of Y¹ and Y² and containing 1-20 carbon atoms, in particular alkylene group, for example linear or branched alkylene group containing 1-6 or 1-3 carbon atoms, and at least one of the above-mentioned functional group is optionally directly connected to E by covalent bond.

According to one embodiment of the invention, protonation compound (c) comprises one or more of:
linear or branched, saturated and unsaturated, optionally —O— containing or —OH substituted C₂-C₃₀ carboxylic acid, preferably ether group-containing carboxylic acid, which has a structure of R^{e}—O-(EO)ₚ—CH₂COOH, wherein p=1-100 and R^{e} is an optionally substituted hydrocarbon group containing 1-20 carbon atoms, preferably alkyl group;
linear or branched C₁₈-C₂₀₀ polymeric fatty acids,
   preferably polymeric fatty acids of the following type:

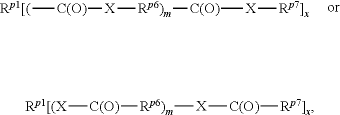

wherein either R^{p1} or at least one of R^{p7}, or both R^{p1} and at least one of R^{p7} bear one ore more of carboxylic group,
   in particular,
   linear polymeric fatty acids of the type

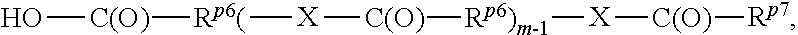

more particularly HO—C(O)—R^{p6}—(O—C(O)—R^{p6})ₘ—O—C(O)—R^{p7},
branched linear polymeric fatty acids, in particular branched linear polymeric fatty acid carboxylates derived from partial esters of polyfunctional carboxylic acids, in particular of the dicarboxylic acids succinic acid and maleic acid, with castor oil or lesquerella oil, such as

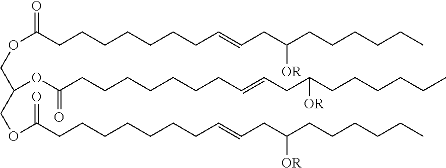

wherein one R in the above formula is

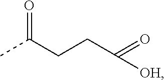

and the remaining two R groups are

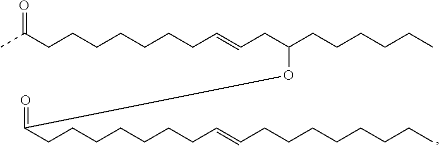

dendritic polymeric fatty acids
or preferably polymeric fatty acids of the following type:

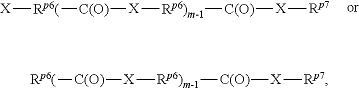

wherein in the two latter types the R^{p7} group bears at least one carboxylic group,
or preferably polymeric fatty acids of the following type:

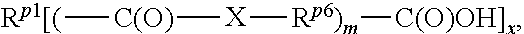

in the structures of the above polymeric fatty acids, independently from one another,
x=1-50, m=1-20, X═O or NR^{p11}, preferably X═O,
R^{p1} is chosen from x-valent, optionally substituted hydrocarbon group which has up to 1000 carbon atoms, preferably 2-300 carbon atoms, more preferably 3-200 carbon atoms, even more preferably 3-150 carbon atoms, in particular 3-50 carbon atoms, more particularly 3-20 carbon atoms, and optionally contains one or more groups chosen from: —O—, —NH—, —C(O)—, —C(S)—, tertiary amino groups

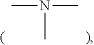

and is optionally substituted by one or more groups selected from OH groups and halide groups;
R^{p6} is independently chosen from optionally substituted straight-chain, cyclic or branched, saturated or unsaturated hydrocarbon group which has 1-36 carbon atoms, preferred 1-24 carbon atoms, more preferred 1-18 carbon atoms, even more preferred 8-18 carbon atoms;
R^{p7} is independently chosen from optionally substituted straight-chain, cyclic or branched, saturated or unsaturated hydrocarbon group which has 1-36 carbon atoms, preferred 1-24 carbon atoms, more preferred 1-18 carbon atoms, even more preferred 8-18 carbon atoms, optionally containing one or more groups chosen from: —O—, —NH—, —C(O)—, —C(S)—, tertiary amino groups

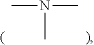

quaternary ammonium group

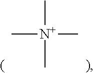

and which is optionally substituted with OH groups or halide groups, wherein R^{p7} group does not contain a combination of a —C(O)— group and a —O— group or a combination of a —C(O)— group and a —NH— or tertiary amino group forming an internal carboxylate group or an internal amide group; with the proviso that at least one R^{p6} has more than 6 carbon atoms;
R^{p11} independently chosen from hydrogen, optionally substituted straight-chain, cyclic or branched, saturated, unsaturated or aromatic hydrocarbon group which has up to 100 carbon atoms, which optionally contains one or more groups chosen from —O—, —NH—, —C(O)—, —C(S)—, tertiary amino groups

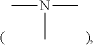

and is optionally substituted with one or more hydroxyl and halide groups;
or preferably polymeric fatty acids of the following type:

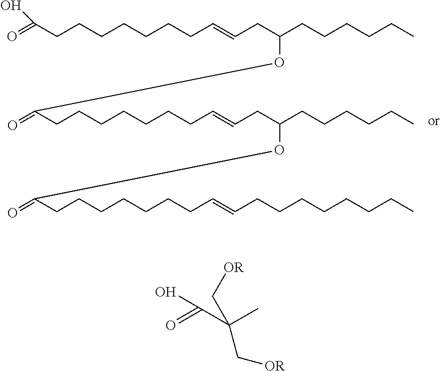

R in the above formula is

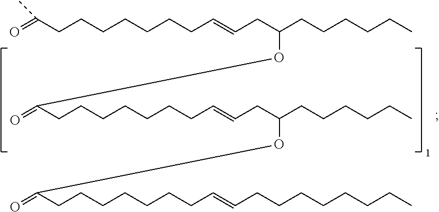

preferably, protonation compound (c) comprises one or more chosen from: acidic amino acid, for example aspartic acid and glutamic acid, lactic acid, 2-ethyl-hexanoic acid, dodecanoic acid, hexadecanoic acid, octadecanoic acid, oleic acid, ricinoleic acid, 12-hydroxy-octadecanoic acid, succinic acid, maleic acid, tartaric acid, polyethercarboxylic acid, citric acid, acetic acid, propionic acid, butyric acid, valeric acid, caproic acid, heptanoic acid, octanoic acid, nonanoic acid, capric acid, undecanoic acid and lauric acid.

According to one embodiment of the invention, protonation compound (d) comprises one or more chosen from the following: acids containing sulfonate group, preferably sulfonic acid substituted with alkyl or aryl group, hydrohalic acid, oxy acids of from V to VI main group elements, acids containing sulfate group, acids containing phosphate group or phosphonate group, carboxylic acid containing 2-20 carbon atoms;
preferably, protonation compound (d) comprises one or more chosen from the following: phosphoric acid, sulfamic acid optionally containing substitution group, methyl sulfamic acid, HCl, methanesulfonic acid, ethanesulfonic acid, benzenesulfonic acid, dodecylbenzenesulfonic acid, sulfuric acid, bisulfate salt, phosphonic acid, aminophosphonic acid or aminocarboxylic acid.

According to one embodiment of the invention, the contents by weight of the components in said reaction relative to the sum of the contents by weight of the components are:
the hydrophobic component (a), 50-95%, preferably 60%-90%, more preferably 70-90%,
the quaternization component (b), 0.1-10%, preferably 0.3-7%, more preferably 0.5-5%,
optional hydrophilic component (e), 0%, or 0.1-10%, preferably 0.3-7%, more preferably 0.5-5%,
the protonation component (p), 0.1%-20%, preferably 0.5-15%, more preferably 1-10%, and
optional reaction medium (f), 0%, or 1-60%, preferably 5-50%, more preferably 10-40%, most preferably reaction medium (f) is consisted of 5-20% of dipropylene glycol n-butyl ether and 5-20% of water,
with the proviso that the sum of the contents by weight of the above components do not exceed 100%.

According to one embodiment of the invention, said polysiloxane polymer composition is acidic, preferably having a pH of from 2 to less than 7, more preferably a pH of from 2 to 6, still more preferably a pH of from 3 to 6, still more preferably a pH of from 4 to 6, most preferably a pH of from 4 to 5.5, in which the pH is measured as follows, pH value is measured after the polysiloxane polymer composition is diluted with mixed solvent in 1:10 weight ratio to 10% in concentration, the mixed solvent is a mixed solvent of isopropanol and water in volume ratio of 5:3,
in particular, in case that the protonation compound (d) is used after the reaction is completed, the pH value is the result of the addition of the protonation compound (d); more particularly, the pH of said polysiloxane polymer composition is from 4.2 to 6, from 4.4 to 6 or from 4.6 to 6, or the pH of said polysiloxane polymer composition is from 4.2 to 5.5, or from 4.4 to 5.5 or from 4.6 to 5.5 or from 4.6 to 5.7.

According to one embodiment of the invention, the molar ratio of protonation component (p) relative to the tertiary amine group in the quaternization component (b) is understoichiometric, stoichiometric or higher, preferably the molar ratio of protonation component (p) relative to the tertiary amine group in the quaternization component (b) is no greater than 0.5, 0.7, 0.9, 1.0, 1.2, 1.4, 1.5, 2, 3 or 4 times of the stoichiometric ratio, preferably the molar ratio of protonation compound (p) relative to the tertiary amine group in the quaternization component (b) is 0.5 to 4:1, more preferred 0.5 to 2:1, 0.7 to 2:1 or 0.9 to 2:1, even more preferred 0.5 to <1:1, 1:1, >1 to 2:1, most preferred >1 to 1.5:1, >1 to 1.4:1 or >1 to 1.2:1.

According to one embodiment of the invention, said reaction is carried out in the presence of a reaction medium (f), preferably including polar solvent and non-polar solvent, the polar solvent preferably chosen from water, alcohols, ethers, esters and glycols, the non-polar solvent preferably chosen from saturated, unsaturated or aromatic hydrocarbons, for example toluene and xylene, preferably, the reaction medium (f) comprises a mixture of water and alcohols or a mixture of water and ethers, in particular a mixture of water and 2-propanol or a mixture of water and dipropylene glycol n-butyl ether, preferably, the mass ratio between dipropylene glycol n-butyl ether and water is from 0.5:1 to 10:1, or 0.7:1 to 7:1, or from 1:1 to 5:1.

According to one embodiment of the invention, the molar ratio between the repeating unit of formula I and the repeating unit of formula II is from 0.1 to 4, or from 1 to 4, or from 2 to 3.

According to one embodiment of the invention, the molar ratio between hydrophobic component (a) and quaternization component (b) is from 1 to 10, or from 2 to 9, or from 3 to 8, or from 4 to 7, or from 5 to 6.

According to one embodiment of the invention, the molar ratio between hydrophilic component (e) and quaternization component (b) is from 0.05 to 0.9, or from 0.1 to 0.8, or from 0.2 to 0.7, or from 0.3 to 0.6, or from 0.4 to 0.5.

According to one embodiment of the invention, in case that protonation compound (d) is used during the reaction, in order to obtain said polysiloxane polymer composition, there is a step of adding protonation compound (d) after the reaction.

According to one embodiment of the invention, in case that protonation compound (d) is used during the reaction, in order to obtain said polysiloxane polymer composition, no protonation compound (d) is added after the reaction.

According to one embodiment of the invention, in case that protonation compound (d) is used after the reaction is completed, said reaction for obtaining said polysiloxane polymer composition is carried out in the presence of protonation compound (d).

According to one embodiment of the invention, in case that protonation compound (d) is used after the reaction is completed, said reaction for obtaining said polysiloxane polymer composition is carried out without protonation compound (d).

According to one embodiment of the invention, in case that protonation compound (d) is used after the reaction is completed, during the reaction, the protonation component (p) comprises at least one protonation compound (c) having a pKa of greater than 3.0 and at least one protonation compound (d) having a pKa of no greater than 3.0, preferably no greater than 2.5, preferably no greater than 2.0, more preferably no greater than 1.5, most preferably no greater than 1.0, and wherein the molar ratio during the reaction between all protonation compound (c) and all protonation compound (d) (ΣMol_{protonation compound (c)}/ΣMol_{protonation compound (d)}) ranges from 9:1 to 0.1:1, preferably from 9:1 to 0.2:1, more preferably from 5:1 to 0.2:1, even more preferably from 2:1 to 0.2:1, most preferably from 2:1 to 0.4:1, still more preferably from 2:1 to 1:1.

According to one embodiment of the invention, in case that protonation compound (d) is used after the reaction is completed, said reaction for obtaining said polysiloxane polymer composition is carried out without protonation compound (d), wherein the molar ratio between all protonation compound (c) and all protonation compound (d) is from 1:0.2 to 1:1.

According to one embodiment of the invention, in case that protonation compound (d) is used during the reaction and after the reaction is completed, the molar ratio between the sum of protonation compound (c) and the protonation compound (d) used during the reaction and the protonation compound (d) added after the reaction is from 1:0.1 to 1:1, preferably from 1:0.2 to 1:1, more preferably from 1:0.2 to 1:0.8, even more preferably from 1:0.2 to 1:0.6, most preferably from 1:02 to 1:0.4.

In one embodiment, the pKa of the protonation compound (d) is no greater than 2.5 and the pKa of the protonation compound (c) is greater than 2.5, or the pKa of the protonation compound (d) is no greater than 2.0 and the pKa of the protonation compound (c) is greater than 2.0.

The invention also provides a method for preparing polysiloxane polymer composition, wherein said method comprises:
reaction of hydrophobic component (a) comprising polysiloxane backbone and quaternization component (b) comprising tertiary amine group in the presence of protonation component (p);
wherein the protonation component (p) comprises at least one protonation compound (c) having a pKa of greater than 3.0 and at least one protonation compound (d) having a pKa of no greater than 3.0, preferably no greater than 2.5, preferably no greater than 2.0, more preferably no greater than 1.5, most preferably no greater than 1.0, and wherein the molar ratio between protonation compound (c) and protonation compound (d) ranges from 9:1 to 0.1:1, preferably from 9:1 to 0.2:1, more preferably from 5:1 to 0.2:1, even more preferably from 2:1 to 0.2:1, most preferably from 2:1 to 0.4:1, still more preferably from 2:1 to 1:1.

According to one embodiment of the invention, in case that protonation compound (d) is used during the reaction, in order to obtain said polysiloxane polymer composition, there is a step of adding protonation compound (d) after the reaction.

According to one embodiment of the invention, in case that protonation compound (d) is used during the reaction, in order to obtain said polysiloxane polymer composition, no protonation compound (d) is added after the reaction.

The invention also provides another method for preparing polysiloxane polymer composition, wherein said method comprises:
reaction of hydrophobic component (a) comprising polysiloxane backbone and quaternization component (b) comprising tertiary amine group in the presence of protonation component (p); protonation component (p) comprises at least one protonation compound (c) having a pKa of greater than 3.0;
addition after said reaction of protonation compound (d) having a pKa of no greater than 3.0, preferably no greater than 2.5, preferably no greater than 2.0, more preferably no greater than 1.5, most preferably no greater than 1.0.

According to one embodiment of the invention, in case that protonation compound (d) is used after the reaction is completed, said reaction for obtaining said polysiloxane polymer composition is carried out in the presence of protonation compound (d).

According to one embodiment of the invention, in case that protonation compound (d) is used after the reaction is completed, said reaction for obtaining said polysiloxane polymer composition is carried out without protonation compound (d).

The polysiloxane polymer composition according to the invention or prepared from the method according to the invention could be used in the field of fiber, textile, cosmetics or personal care.

Polysiloxane polymer composition according to the invention has Dn content below 1000 ppm, which makes the polysiloxane polymer composition of the invention more environment friendly comparing to the polysiloxane polymer composition of the prior art, and meet the requirement regarding Dn content set by European Chemicals Agency (ECHA).

### DETAILED DESCRIPTION OF THE APPLICATION

### Polysiloxane Polymer Composition and the Preparation Method Thereof

Polysiloxane polymer composition according to the invention is a composition comprising polysiloxane polymer, wherein polysiloxane polymer at least comprises polysiloxane moiety (hydrophobic moiety) and quaternary ammonium moiety and optionally other moieties, for example hydrophilic moiety.

In the context of the invention, unless otherwise specified, expressions like ‘hydrocarbon group’, ‘hydrocarbon chain’, ‘alkyl group’ or alkylene group’ used in various components are meant to cover molecular moieties of any form, for example molecular moieties in forms of optionally substituted, saturated or unsaturated (for hydrocarbon group or chain), linear, branched or cyclic.

Currently, the method of preparing the above-mentioned polysiloxane polymer relies on performing a reaction of hydrophobic component (a) comprising polysiloxane backbone and quaternization component (b) comprising tertiary amine group, and optionally other components (for example hydrophilic component (e)) in the presence of protonation component (p), wherein protonation component (p) is an acid, the used amount of which roughly equals to the stoichiometric ratio relative to the tertiary amine group in quaternization component (b). After the reaction is completed (after the reaction), polysiloxane polymer composition is obtained, which is normally basic and contains a relatively high content of Dn, for example above 1000 ppm of D4 content.

Not wishing to be bound by theory, the inventor found based on experiments and research that polymer containing quaternary ammonium moiety which contains positive charge and polysiloxane moiety has a tendency to generate high content of Dn under basic condition. Thus, adjusting the reaction product mixture to be acidic facilitates reducing Dn content.

The inventor found based on experiments that if an amount of strong acid (corresponding to protonation compound (d), referring to an acid having a pKa no greater than 3.0, preferably no greater than 2.5, preferably no greater than 2.0, more preferably no greater than 1.5, most preferably no greater than 1.0 in this context) is used during the above-mentioned reaction, the polysiloxane polymer composition obtained after the reaction has relatively low Dn content.

It is found that Dn content is reduced when the molar ratio of protonation component (p) relative to the tertiary amine group in the quaternization component (b) is understoichiometric, stoichiometric or higher, preferably the molar ratio of protonation component (p) relative to the tertiary amine group in the quaternization component (b) is no greater than 0.5, 0.7, 0.9, 1.0, 1.2, 1.4, 1.5, 2, 3 or 4 times of the stoichiometric ratio, preferably the molar ratio of protonation compound (p) relative to the tertiary amine group in the quaternization component (b) is 0.5 to 4:1, more preferred 0.5 to 2:1, 0.7 to 2:1 or 0.9 to 2:1, even more preferred 0.5 to <1:1, 1:1, >1 to 2:1, most preferred >1 to 1.5:1, >1 to 1.4:1 or >1 to 1.2:1.

In addition, in case that strong acid is used during the reaction, it is found that during the reaction, when the molar ratio between protonation compound (c) and protonation compound (d) ranges from 9:1 to 0.1:1, preferably from 9:1 to 0.2:1, more preferably from 5:1 to 0.2:1, even more preferably from 2:1 to 0.2:1, most preferably from 2:1 to 0.4:1, still more preferably from 2:1 to 1:1, it facilitates reducing D4 content.

In another aspect, the inventor found on basis of experiment that regardless if strong acid is used during the reaction or not, when the strong acid (corresponding to protonation compound (d)) is added to the reaction product mixture after the reaction process is completed, it is found that the obtained polysiloxane polymer composition has relatively low Dn content. Therefore, in case that the strong acid is used after the reaction, it is preferably to make polysiloxane polymer composition acidic, polysiloxane polymer composition preferably having a pH of from 2 to less than 7, more preferably a pH of from 2 to 6, still more preferably a pH of from 3 to 6, still more preferably a pH of from 4 to 6, most preferably a pH of from 4 to 5.5, in which the pH is measured as follows, pH value is measured after the polysiloxane polymer composition is diluted with mixed solvent in 1:10 weight ratio to 10% in concentration, the mixed solvent is a mixed solvent of isopropanol and water in volume ratio of 5:3, in particular, in case that the protonation compound (d) is used after the reaction is completed, the pH value is the result of the addition of the protonation compound (d); more particularly, the pH of said polysiloxane polymer composition is from 4.2 to 6, from 4.4 to 6 or from 4.6 to 6, or the pH of said polysiloxane polymer composition is from 4.2 to 5.5, or from 4.4 to 5.5 or from 4.6 to 5.5 or from 4.6 to 5.7.

As a non-limiting example, the above advantageous pH ranges may be suitable for a reaction system, in which the contents by weight of the components in said reaction relative to the sum of the contents by weight of the components are:
the hydrophobic component (a), 50-95%, preferably 60%-90%, more preferably 70-90%,
the quaternization component (b), 0.1-10%, preferably 0.3-7%, more preferably 0.5-5%,
optional hydrophilic component (e), 0%, or 0.1-10%, preferably 0.3-7%, more preferably 0.5-5%,
the protonation component (p), 0.1%-20%, preferably 0.5-15%, more preferably 1-10%, and
optional reaction medium (f), 0%, or 1-60%, preferably 5-50%, more preferably 10-40%, most preferably reaction medium (f) is consisted of 5-20% of dipropylene glycol n-butyl ether and 5-20% of water,
with the proviso that the sum of the contents by weight of the above components do not exceed 100%.

If the protonation compound (d) in protonation component (p) is added in the form of aqueous solution, the content by weight of the protonation compound (d) in protonation component (p) is expressed by the weight of aqueous solution.

In case that protonation compound (d) is used after the reaction is completed, said reaction for obtaining said Polysiloxane polymer composition could be performed in the absence of protonation compound (d), in which case the molar ratio between all protonation compound (c) and all protonation compound (d) is from 1:0.2 to 1:1, which could achieve reduced Dn content.

In addition, in case that protonation compound (d) is used after the reaction is completed, during the reaction, protonation component (p) could also comprise protonation compound (d), and wherein the molar ratio during the reaction between all protonation compound (c) and all protonation compound (d) (ΣMol_{protonation compound (c)}/ΣMol_{protonation compound (d)}) ranges from 9:1 to 0.1:1, preferably from 9:1 to 0.2:1, more preferably from 5:1 to 0.2:1, even more preferably from 2:1 to 0.2:1, most preferably from 2:1 to 0.4:1, still more preferably from 2:1 to 1:1. In case that protonation compound (d) is used during the reaction and after the reaction is completed, the molar ratio between the sum of protonation compound (c) and the protonation compound (d) used during the reaction and the protonation compound (d) added after the reaction is from 1:0.1 to 1:1, preferably from 1:0.2 to 1:1, more preferably from 1:0.2 to 1:0.8, even more preferably from 1:0.2 to 1:0.6, most preferably from 1:02 to 1:0.4. It is found that using the above content of protonation compounds facilities achieving reduced Dn content.

Unless otherwise indicated, pH mentioned in the invention all refer to pH value measured as follows: the analyte (for example polysiloxane polymer composition or reactant mixture) is diluted with mixed solvent to 10% in concentration (1:10 dilution in weight ratio) and then pH value is measured. The mixed solvent for dilution is a mixed solvent of isopropanol and water in volume ratio of 5:3. After the analyte and the mixed solvent are thoroughly mixed and uniformly dissolved, pH value is measured using S20 SevenEasy™ pH meter from Mettler Toldeo. Said 1:10 dilution refers to diluting 1 part by weight of analyte with 9 parts by weight of the mixed solvent.

The inventor found on basis of the above study that optimal result could be achieved by using the strong acid both during the reaction and after the reaction is completed. Specifically, using strong acid during the reaction process could reduce the Dn content generated during the reaction. Then, using the strong acid after the reaction is completed could reduce the Dn content generated during storage. The overall result relates to the reduction of Dn (such as D4) content in the main processes of which polysiloxane polymer is produced and stored. Apparently, the invention is not limited to this optimal mode of embodiments. The use of strong acid during the reaction process and after the reaction is completed could be carried out separately or together.

In addition, in case that strong acid is used both during the reaction and after the reaction is completed, the strong acid used both during the reaction and after the reaction is completed could be the same or different, although the same wording of ‘strong acid’ is used. In the invention, expression of ‘protonation compound (d)’ means one or more strong acids which meet the definition of the invention. This principle applies to other components/ingredients. When ‘protonation compound (d)’ is used both during the reaction and after the reaction is completed, ‘protonation compound (d)’ used both during the reaction and after the reaction is completed could be the same or different.

In view of the above, several preferred ways to obtain polysiloxane polymer composition could be summarized as follows.

In order to obtain polysiloxane polymer composition, protonation compound (d) is used exclusively during the above-mentioned reaction.

In order to obtain polysiloxane polymer composition, protonation compound (d) is added or used exclusively after the above-mentioned reaction.

In order to obtain polysiloxane polymer composition, protonation compound (d) is used during the above-mentioned reaction and is added after the above-mentioned reaction.

It can be seen that the inventor found a method of effectively reducing Dn content. Since quaternary ammonium moiety bearing positive charge and polysiloxane moiety as well as the basic condition are the factors leading to high Dn content, the invention is not limited to reducing the Dn content generated during the preparation and storage of the polymer containing only the quaternary ammonium moiety and polysiloxane moiety. When the polymer contains moieties in addition to the quaternary ammonium moiety and polysiloxane moiety, it is believed that the inventive solution could reduce the Dn content generated during the synthesis and/or storage of such polymer.

For example, the inventor conducted a reaction by using hydrophobic component (a) containing polysiloxane backbone, quaternization component (b) comprising tertiary amine group and hydrophilic component (e) (optional component, preferably containing amine group) in the presence of protonation component (p) which comprises protonation compound (d). It is found that the obtained polysiloxane polymer composition has low Dn content. In another aspect, if the strong acid is added after the above-mentioned reaction (no strong acid is present during the reaction), it is found that the obtained polysiloxane polymer composition also has low Dn content.

In the above exemplary system, hydrophilic component (e) together with hydrophobic component (a) is used to adjust the hydrophilicity-hydrophobicity of the polysiloxane polymer. A skilled person knows that the content of hydrophilic component (e) could be determined according to the specific application of polysiloxane polymer. Likewise, the ratio between quaternization component (b) and other components could also be determined according to the specific application of polysiloxane polymer. Thus, there is no special limitation to the contents of various repeating units in the polysiloxane polymer involved in the invention, such contents could be adjusted as needed. The same principle applies to the size or length of hydrophilic component (e) and hydrophobic component (a).

Therefore, for the compositional components of polysiloxane polymer, besides that the polymer contains polysiloxane moiety and quaternary ammonium moiety, the compositional components of the inventive polysiloxane polymer are not specially limited. The ratio between various components is not specially limited either.

As a non-limiting example of the compositional repeating units in the polymer, the molar ratio between the repeating unit of formula I as defined above and the repeating unit of formula II as defined above is from 0.1 to 4, or from 1 to 4, or from 2 to 3. As a non-limiting example of the contents of various components in the reaction of the preparation method, the molar ratio between hydrophobic component (a) and quaternization component (b) is from 1 to 10, or from 2 to 9, or from 3 to 8, or from 4 to 7, or from 5 to 6; the molar ratio between hydrophilic component (e) (if present) and quaternization component (b) is from 0.05 to 0.9, or from 0.1 to 0.8, or from 0.2 to 0.7, or from 0.3 to 0.6, or from 0.4 to 0.5.

In addition, the length of the repeating units in the polymer could be adjusted as needed, and is not superficially limited.

In order to reduce Dn content, the inventor found that it is necessary to use strong acid having a pKa of no greater than 3.0 during the reaction and/or after the reaction. If weak acid is solely used for the reaction or if weak acid is solely added after the reaction, the Dn content could not effectively reduced. For example, the inventor found in the experiments that using lauric acid (pKa=6.92) and acetic acid (pKa=4.76) (both are protonation compound (c)) as protonation component (p) without adding any strong acid having a pKa of no greater than 3.0 during the reaction process, D4 content in the obtained reaction product mixture is above 1000 ppm. Adding citric acid (pKa=3.13, protonation compound (c)) after the reaction to the product mixture, it is found that D4 content is above 1000 ppm after the obtained mixture is aged at 85° C. for 24 hours.

In contrast, when methanesulfonic acid (pKa=2, strong acid, protonation compound (d)) is added during the reaction process, D4 content in the obtained reaction product mixture is below 1000 ppm. When methanesulfonic acid is added to the product mixture after the reaction, and it is found that D4 content is still below 1000 ppm after the obtained mixture is aged at 50° C. for 4 weeks.

Dn in the invention could be measured by the following method, in which 0.5 g (e.g., accurate to 0.1 mg) sample is weighed and placed into a 20 mL glass bottle into which 10 mL of a mixed solvent of methanol and toluene (volume ratio of methanol to toluene is 1:2) is accurately added, and there is 0.05 mg/mL n-dodecane contained in the mixed solvent as internal standard. After thorough mixing is carried out, the mixture is placed on a shaking table for 4 h of shaking. The supernatant is taken and tested for D4, D5 and D6 contents using Agilent 6890 gas chromatograph, DB-5 (60 m×0.25 mm×0.25 um) chromatographic column after it is filtered with needle type filter head for organic phase.

Non-limiting examples of protonation compound (d) as strong acid include: acids containing sulfonate group, preferably sulfonic acid substituted with alkyl or aryl group, hydrohalic acid, oxy acids of from V to VI main group elements, acids containing sulfate group, acids containing phosphate group or phosphonate group, or carboxylic acid containing 2-20 carbon atoms;
preferably, protonation compound (d) comprises one or more chosen from the following: phosphoric acid, sulfamic acid optionally containing substitution group, methyl sulfamic acid, HCl, methanesulfonic acid, ethanesulfonic acid, benzenesulfonic acid, dodecylbenzenesulfonic acid, sulfuric acid, bisulfate salt, phosphonic acid, aminophosphonic acid or aminocarboxylic acid.

The above exemplary protonation compounds (d) are those having pKa of no greater than 3.0, preferably no greater than 2.5, preferably no greater than 2.0, more preferably no greater than 1.5, most preferably no greater than 1.0. For example, for carboxylic acid containing 2-20 carbon atoms, protonation compound (d) according to the invention is the carboxylic acid with strong acid attribute, for example trifluoroacetic acid. In other wards, carboxylic acid containing 2-20 carbon atoms whose pKa does not fit the definition of the invention is not within the scope of the protonation compound (d) of the invention.

There is no special requirement for the protonation compound (c) of the invention. The example of protonation compound (c) of the invention is defined as in the Summary of the invention. As the protonation compound (c), its role in such reactions is usually providing protons. Thus, in one embodiment, the pKa of the protonation compound (d) is no greater than 2.5 and the pKa of the protonation compound (c) is greater than 2.5, or the pKa of the protonation compound (d) is no greater than 2.0 and the pKa of the protonation compound (c) is greater than 2.0.

There are commercially available products for the polysiloxane polymer involved in the invention, which means that the preparation method for such type of polysiloxane polymer is known. However, the prior art method leads to high Dn content. The method for preparing polysiloxane polymer containing quaternary ammonium moiety belongs to the ordinary skill of a skilled person, except the use of strong acid. In other words, a skilled person is capable of using suitable reaction conditions, including temperature, reaction time, reaction medium and the like, to carry out the preparation method (except the use of the strong acid). For example, such type of reaction could be carried out at 30-180° C. until the reaction is completed.

The preparation method of the invention could be carried in the presence of reaction medium(f) as needed. Reaction medium (f) preferably includes polar solvent and non-polar solvent, the polar solvent preferably chosen from water, alcohols, ethers, esters and glycols, the non-polar solvent preferably chosen from saturated, unsaturated or aromatic hydrocarbons, for example toluene and xylene. Preferably, the reaction medium (f) comprises a mixture of water and alcohols or a mixture of water and ethers, in particular a mixture of water and 2-propanol or a mixture of water and dipropylene glycol n-butyl ether. The choice of solvent and the proportion could be adjust as needed. Preferably, the mass ratio between dipropylene glycol n-butyl ether and water is from 0.5:1 to 10:1, or 0.7:1 to 7:1, or from 1:1 to 5:1.

The polysiloxane polymer composition according to the invention or prepared from the method according to the invention could be used in the field of fiber, textile, cosmetics or personal care. A skilled person knows that the polysiloxane polymer comprising quaternary ammonium moiety could be used to treat fibers or textiles, for example as part of the composition for such purpose, and could be used in cosmetics or personal care. The use of polysiloxane polymer composition is a known practice in these fields. In view of the low Dn content of the inventive polysiloxane polymer composition, it would be more environmentally friendly to use the inventive polysiloxane polymer composition in the field of fiber, textile, cosmetics or personal care comparing to the conventional polysiloxane polymer composition.

The invention can be beneficially applied to any silicone bearing quaternized ammonium moieties.

This includes i.e. monofunctional quaternized silicones, α,ω-di-quaternized silicones of the ABA type, center quaternized silicones of the BAB type, α,ω-poly quaternized silicones of the ABA type bearing more than one quaternized ammonium moiety on both chain termini, T or Q branched silicones having terminal quaternized ammonium moieties, poly quaternized poly loop silicones of the (AB)n type, poly quaternized poly loop silicones of the (AB)n type partially containing terminal ester groups, silicones bearing the quaternized ammonium moieties in pending side chains.

Optionally, these quaternized silicones contain alkylene oxide moieties, preferentially derived from ethylene oxide, propylene oxide, butylene oxide or glycidol. The incorporation of these alkylene oxide moieties can be accomplished i.e., by using the respective amino derivatives, chloroacetic acid derivatives or glycidyl derivatives.

Preferred precursors for the incorporation of the silicone moieties are i.e., the tertiary amino derivatives, chloroacetic acid derivatives, haloalkyl derivatives and glycidyl derivatives.

### EXAMPLES

The present invention is hereinafter described by way of example and is not limited to the below examples.

### Used Materials:

| Components | Substance |
|---|---|
| hydrophobic component (a) | polysiloxane terminated with epoxy groups, which is epoxy- |
| | modified silicone oil having the following formula: |
| | 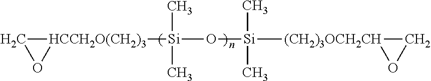 |
| | Epoxy value: 0.022 mol/100 g |
| quaternization component | N,N,N′,N′-tetramethyl-1,6-hexanediamine (TMHDA) |
| (b) | |
| protonation compound (c) | lauric acid (pKa = 4.92); |
| | acetic acid (pKa = 4.76); |
| | citric acid (pKa = 3.13) |
| protonation compound (d) | HCl (36.5%, pKa = −6.3); |
| | sulfamic acid (pKa = 1.0); |
| | ethanesulfonic acid (pKa = 1.83); |
| | methanesulfonic acid (pKa = −2.0); |
| | H₂SO₄(20%, pKa = −3) |
| hydrophilic component (e) | Jeffamin (Jeffamin ED-600, from Huntsman) |
| reaction medium(f) | water/dipropylene glycol n-butyl ether(DPnB) |

*Jeffamin is a type of polyetheramine, i.e., compound having amine group at the terminial and containing polyether repeating units, which is commercially available.

### Methods for Measurement

pH measurement: the analyate is diluted with a mixed solvent (1:10 dilution). After the analyte and the mixed solvent are thoroughly mixed and uniformly dissolved, pH value is measured using S20 SevenEasy™ pH meter from Mettler Toldeo. The mixed solvent for dilution is a mixed solvent of isopropanol and water in volume ratio of 5:3. Said 1:10 dilution refers to diluting 1 part by weight of analyte with 9 parts by weight of the mixed solvent.

Measurement of Dn (D4, D5, D6): 0.5 g sample is weighed and placed into a 20 mL glass bottle into which 10 mL of a mixed solvent of methanol and toluene (volume ratio of methanol to toluene is 1:2) is accurately added, and there is 0.05 mg/mL n-dodecane contained in the mixed solvent as internal standard. After thorough mixing is carried out, the mixture is placed on a shaking table for 4 h of shaking. The supernatant is taken and tested for D4, D5 and D6 contents using Agilent 6890 gas chromatograph, DB-5 (60 m×0.25 mm×0.25 um) chromatographic column after it is filtered with needle type filter head for organic phase.

### Experiment 1—Study of Dn Content when No Strong Acid is Used During and after the Reaction

### 1-1 the Following Experiment is Carried Out for Examing Dn Level in the Product Mixture Obtained from the Reaction, when No Strong Acid is Used Either During and after the Reaction

### Comparative Example 1

8.98 g of Jeffamin (0.0150 mol), 9.71 g of TMHDA (0.0564 mol), 16.94 g of lauric acid (0.0847 mol), 9.28 g of acetic acid (0.0564 mol), 67.12 g of DPnB and 31.19 g of water are charged into a reactor and mixed, so as to obtain a solution. Then, 600 g of epoxy terminated polysiloxane (0.0706 mol) is added. Under mixing, the reaction is carried out at 95° C. for 12 hours to obtain the product.

There is 1183 ppm of D4, 409 ppm of D5 and 611 ppm of D6 contained in the product. After the product is diluted with the mixed solvent to 10% in concentration, the measured pH is 9.2.

It can be seen that when no strong acid is used during and after the reaction (protonation component is composed of only weak acid), the product mixture obtained from the reaction has above 1000 ppm of D4, and pH indicates alkaline characteristic.

### 1-2 the Following Experiment is Carried Out for Examing Dn Level Generated in the Product Mixture after Aging, when No Strong Acid is Used Either During and after the Reaction

### Comparative Example 2

17.73 g of Jeffamin (0.014 mol), 11.64 g of TMHDA (0.032 mol), 29.54 g of lauric acid (0.07 mol), 4.73 g of acetic acid (0.0373 mol), 47.2 g of DPnB and 18.36 g of water are charged into a reactor and mixed, so as to obtain a solution. Then, 400 g of epoxy terminated polysiloxane (0.0466 mol) is added. Under mixing, the reaction is carried out at 85° C. for 10 hours to obtain the product. The product is aged at 85° C. for 24 hours. After the product is diluted with the mixed solvent to 10% in concentration, the measured pH is 8.9. The inventor found that aging does not substantially change the pH of the composition.

There is 1226 ppm of D4, 277 ppm of D5 and 40 ppm of D6 contained in the product.

It can be seen that when no strong acid is used either during and after the reaction (protonation component is composed of only weak acid), the composition has above 1000 ppm of D4 after aging, and pH indicates alkaline characteristic.

### 1-3 the Following Experiments are Carried Out for Examing Dn Level Generated in the Product Mixture after Aging, when Weak Acid is Added after the Reaction

### Comparative Example 3

5.6 g of Jeffamin (0.0093 mol), 6.31 g of TMHDA (0.0367 mol), 9.33 g of lauric acid (0.0466 mol), 2.24 g of acetic acid (0.0373 mol), 43.79 g of DPnB and 19.46 g of water are charged into a reactor and mixed, so as to obtain a solution. Then, 400 g of epoxy terminated polysiloxane (0.0466 mol) is added. Under mixing, the reaction is carried out at 85° C. for 10 hours to obtain the product. After the product is diluted with the mixed solvent to 10% in concentration, the measured pH is 9.2.

0.79 g of acetic acid and 8 g of DPnB are added to 100 g of the reaction product. Then, aging at 85° C. is carried out for 24 hours.

There is 1588 ppm of D4, 393 ppm of D5 and 147 ppm of D6 contained in the product. After the product is diluted with the mixed solvent to 10% in concentration, the measured pH is 6.

### Comparative Example 4

Comparative example 2 is repeated, except that after the reaction is completed, 2 g of citric acid and 5 g of DPnB are added to 100 g of reaction product. Then, the same aging step is carried out. After the product is diluted with the mixed solvent to 10% in concentration, the measured pH is 5.7.

There is 1534 ppm of D4, 265 ppm of D5 and 41 ppm of D6 contained in the product.

It can be seen that when weak acid is added after the reaction is completed, the product mixture obtained from the reaction has above 1000 ppm of D4 after aging. It is worth noting that although the pH value of the product mixture is reduced, there is a large amount of D4 generated in Comparative example 3 and 4 because no strong acid is used.

### Experiment 2—Study of Dn Content when Strong Acid is Used During the Reaction

### Example 1

8.4 g of Jeffamin (0.014 mol), 9.23 g of TMHDA (0.054 mol), 16.79 g of lauric acid (0.084 mol), 7 g of 36.5% HCl aqueous solution (0.07 mol), 65.97 g of DPnB and 21.21 g of water are charged into a reactor and mixed, so as to obtain a solution. Then, 600 g of epoxy terminated polysiloxane (0.0706 mol) is added. Under mixing, the reaction is carried out at 85° C. for 8 hours to obtain a product.

There is 349 ppm of D4, 972 ppm of D5 and 218 ppm of D6 contained in the product. After the product is diluted with the mixed solvent to 10% in concentration, the measured pH is 9.

It can be seen that when strong acid is used in the reaction, a reduction of pH for the reactant mixture facilitates obtaining a relatively low D4 content; and the D4 content after aging is also reduced.

### Example 2

5.6 g of Jeffamin (0.0093 mol), 6.31 g of TMHDA (0.0367 mol), 10.26 g of lauric acid (0.0513 mol), 1.96 g of acetic acid (0.0326 mol), 2.26 g of sulfamic acid (0.0233 mol), 46.11 g of DPnB and 46.11 g of water are charged into a reactor and mixed, so as to obtain a solution. Then, 400 g of epoxy terminated polysiloxane (0.0466 mol) is added. Under mixing, the reaction is carried out at 85° C. for 16 hours to obtain a product.

There is 133 ppm of D4, 313 ppm of D5 and 548 ppm of D6 contained in the product. After the product is diluted with the mixed solvent to 10% in concentration, the measured pH is 7.8.

### Example 3

5.6 g of Jeffamin (0.0093 mol), 6.31 g of TMHDA (0.0367 mol), 9.33 g of lauric acid (0.0466 mol), 1.96 g of acetic acid (0.0326 mol), 1.95 g of ethanesulfonic acid (0.0186 mol), 42.36 g of DPnB and 9.31 g of water are charged into a reactor and mixed, so as to obtain a solution. Then, 400 g of epoxy terminated polysiloxane (0.0466 mol) is added. Under mixing, the reaction is carried out at 85° C. for 10 hours to obtain the product.

There is 499 ppm of D4, 552 ppm of D5 and 689 ppm of D6 contained in the product. After the product is diluted with the mixed solvent to 10% in concentration, the measured pH is 8.4.

### Example 4

4.2 g of Jeffamin (0.007 mol), 4.74 g of TMHDA (0.0275 mol), 7 g of lauric acid (0.035 mol), 3.36 g of methanesulfonic acid (0.035 mol), 32.47 g of DPnB and 9.02 g of water are charged into a reactor and mixed, so as to obtain a solution. Then, 300 g of epoxy terminated polysiloxane (0.035 mol) is added. Under mixing, the reaction is carried out at 85° C. for 12 hours to obtain the product.

There is 226 ppm of D4, 50 ppm of D5 and 52 ppm of D6 contained in the product. After the product is diluted with the mixed solvent to 10% in concentration, the measured pH is 8.2.

### Example 5

5.6 g of Jeffamin (0.0093 mol), 6.15 g of TMHDA (0.0357 mol), 9.33 g of lauric acid (0.0466 mol), 11.43 g of 20% H₂SO₄ aqueous solution (0.0233 mol), 36.57 g of DPnB and 10.74 g of water are charged into a reactor and mixed, so as to obtain a solution. Then, 400 g of epoxy terminated polysiloxane (0.0466 mol) is added. Under mixing, the reaction is carried out at 85° C. for 8 hours to obtain a product.

There is 414 ppm of D4, 412 ppm of D5 and 42 ppm of D6 contained in the product. After the product is diluted with the mixed solvent to 10% in concentration, the measured pH is 7.8.

It can be seen that adding strong acid during the reaction could reduce the Dn content in the product mixture.

### Experiment 3—Study of Dn Content when No Strong Acid is Added During the Reaction but Strong Acid is Added after the Reaction is Completed

### Example 6

Comparative example 3 is repeated, except that 1 g of methanesulfonic acid and 8 g of DPnB are added to 100 g of the product obtained from the reaction. Then, aging is carried out at 85° C. for 24 hours.

There is 780 ppm of D4, 203 ppm of D5 and 96 ppm of D6 contained in the product. After the product is diluted with the mixed solvent to 10% in concentration, the measured pH is 6.

### Example 7

Comparative example 3 is repeated, except that 4.8 g of 20% sulfamic acid aqueous solution and 8 g of DPnB are added to 100 g of the product obtained from the reaction. Then, aging is carried out at 85° C. for 24 hours.

There is 361 ppm of D4, 81 ppm of D5 and 45 ppm of D6 contained in the product. After the product is diluted with the mixed solvent to 10% in concentration, the measured pH is 6.

It can be seen from Example 6 and Example 7 that even if no strong acid is used during the reaction, adding strong acid after the reaction is completed could still obtain low Dn content, especially D4 content.

It can be seen from the comparison of Example 6 and Example 7 with Comparative example 3 that adding weak acid after the reaction is completed still could not effectively reduce D4 content even though pH is adjusted to be acidic.

### Experiment 4—Study of Dn Content when Strong Acid is Added Both During the Reaction and after the Reaction is Completed

### Example 8

Example 1 is repeated, except that 36.5% HCl aqueous solution is added after reaction such that the pH of the product mixture is 4.6 (measured after it is diluted to 10% in concentration), and then the product mixture is aged at 85° C. for 40 hours.

There is 311 ppm of D4, 263 ppm of D5 and 632 ppm of D6 contained in the product.

Next, 3 months of aging is carried out at 50° C. There is 806 ppm of D4, 405 ppm of D5 and 686 ppm of D6 contained in the product.

### Example 9

Example 1 is repeated, except that 36.5% HCl aqueous solution is added after reaction such that the pH of the product mixture is 6 (measured after it is diluted to 10% in concentration), and then the product mixture is aged at 85° C. for 40 hours.

There is 443 ppm of D4, 296 ppm of D5 and 664 ppm of D6 contained in the product.

### Example 10

Example 1 is repeated, except that 36.5% HCl aqueous solution is added after reaction such that the pH of the product mixture is 6.7 (measured after it is diluted to 10% in concentration), and then the product mixture is aged at 85° C. for 40 hours.

There is 550 ppm of D4, 316 ppm of D5 and 548 ppm of D6 contained in the product.

### Example 11

5.59 g of Jeffamin (0.0466 mol), 6.31 g of TMHDA (0.0367 mol), 9.33 g of lauric acid (0.0466 mol), 3.58 g of methanesulfonic acid (0.0373 mol), 48.27 g of DPnB and 9.65 g of water are charged into a reactor and mixed, so as to obtain a solution. Then, 400 g of epoxy terminated polysiloxane (0.0466 mol) is added. Under mixing, the reaction is carried out at 85° C. for 20 hours to obtain a product.

Then, 10 g of 14% sulfamic acid aqueous solution and 8 g of DPnB are added to 130 g of the obtained product. At 50° C., aging is carried out for 4 weeks.

There is 667 ppm of D4, 218 ppm of D5 and 59 ppm of D6 contained in the product. After the product is diluted with the mixed solvent to 10% in concentration, the measured pH is 4.8.

### Example 12

Example 11 is repeated, except that 1 g of methanesulfonic acid and 5 g of DPnB are added to 80 g of the obtained product. At 50° C., aging is carried out for 4 weeks.

There is 358 ppm of D4, 159 ppm of D5 and 93 ppm of D6 contained in the product. After the product is diluted with the mixed solvent to 10% in concentration, the measured pH is 5.4.

### Example 13

Example 11 is repeated, except that 6 g of 14% sulfamic acid aqueous solution and 5 g of DPnB are added to 80 g of the obtained product. At 50° C., aging is carried out for 4 weeks.

There is 324 ppm of D4, 93 ppm of D5 and 33 ppm of D6 contained in the product. After the product is diluted with the mixed solvent to 10% in concentration, the measured pH is 5.3.

Since strong acid is used both during the reaction process and after the reaction is completed, Dn content is still not exceeding 1000 ppm after aging for 4 weeks.

The above example section of the invention shows that a low cyclics (Dn) content can be achieved by
using protonation compound (d) in combination with protonation compound (c) during the reaction (quaternization);
adding protonation compound (d) after quaternization with protonation compound (c);
using protonation compound (d) in combination with protonation compound (c) during the quaternization and subsequent addition of protonation compound (d) after the quaternization.

### Experiment 5—Supplemental Study of Dn Content when Strong Acid is Added after the Reaction is Completed: The Effect of the Range of pH Value

The following examples are not intended to limit the invention into specific embodiments, and are to illustrate the preferred embodiments of the invention instead.

### Comparative Example 5

5.60 g of Jeffamin (0.0093 mol), 6.31 g of TMHDA (0.0367 mol), 9.33 g of lauric acid (0.0466 mol), 2.24 g of acetic acid (0.0373 mol), 39.27 g of DPnB and 19.47 g of water are charged into a reactor and mixed, so as to obtain a solution. Then, 400 g of epoxy terminated polysiloxane (0.0706 mol) is added. Under mixing, the reaction is carried out at 85° C. for 10 hours to obtain the product.

The pH of the obtained product is measured to be 9.5 (measured after it is diluted to 10% in concentration).

After the product is stored at room temperature for 7 days, the test result shows that there is 1052 ppm of D4, 214 ppm of D5 and 377 ppm of D6 contained in the product.

After the product is aged at 50° C. for 2 weeks, there is 1823 ppm of D4, 346 ppm of D5 and 409 ppm of D6 contained in the product.

This comparative example illustrates that when no strong acid is added after the reaction is completed, the D4 content after storage at room temperature for 7 days is already very high, and the D4 content significantly increases after aging.

### Example 14

Comparative example 5 is repeated, except that 1 g of 20% sulfamic acid aqueous solution and 3 g of DPnB are added into 57 g of the obtained product. The pH of the obtained product is measured to be 7.4 (measured after it is diluted to 10% in concentration).

After the product is stored at room temperature for 7 days, the test result shows that there is 588 ppm of D4, 137 ppm of D5 and 306 ppm of D6 contained in the product.

After the product is aged at 50° C. for 2 weeks, there is 1074 ppm of D4, 260 ppm of D5 and 343 ppm of D6 contained in the product.

### Example 15

Comparative example 5 is repeated, except that 1.5 g of 20% sulfamic acid aqueous solution and 2.5 g of DPnB are added into 53.8 g of the obtained product. The pH of the obtained product is measured to be 6.6 (measured after it is diluted to 10% in concentration).

After the product is stored at room temperature for 7 days, the test result shows that there is 509 ppm of D4, 134 ppm of D5 and 303 ppm of D6 contained in the product.

After the product is aged at 50° C. for 2 weeks, there is 1015 ppm of D4, 267 ppm of D5 and 372 ppm of D6 contained in the product.

### Example 16

Comparative example 5 is repeated, except that 6 g of 20% sulfamic acid aqueous solution and 4 g of DPnB are added into 64.5 g of the obtained product. The pH of the obtained product is measured to be 3.5 (measured after it is diluted to 10% in concentration).

After the product is stored at room temperature for 7 days, the test result shows that there is 593 ppm of D4, 160 ppm of D5 and 324 ppm of D6 contained in the product.

After the product is aged at 50° C. for 2 weeks, there is 1033 ppm of D4, 275 ppm of D5 and 313 ppm of D6 contained in the product.

### Example 17

Comparative example 5 is repeated, except that 3 g of 20% sulfamic acid aqueous solution and 2.5 g of DPnB are added into 50.2 g of the obtained product. The pH of the obtained product is measured to be 5.7 (measured after it is diluted to 10% in concentration).

After the product is stored at room temperature for 7 days, the test result shows that there is 429 ppm of D4, 121 ppm of D5 and 284 ppm of D6 contained in the product.

After the product is aged at 50° C. for 2 weeks, there is 854 ppm of D4, 246 ppm of D5 and 337 ppm of D6 contained in the product.

### Example 18

Comparative example 5 is repeated, except that 4.5 g of 20% sulfamic acid aqueous solution and 3 g of DPnB are added into 53.5 g of the obtained product. The pH of the obtained product is measured to be 4.6 (measured after it is diluted to 10% in concentration).

After the product is stored at room temperature for 7 days, the test result shows that there is 400 ppm of D4, 91 ppm of D5 and 272 ppm of D6 contained in the product.

After the product is aged at 50° C. for 2 weeks, there is 584 ppm of D4, 154 ppm of D5 and 295 ppm of D6 contained in the product.

Comparing examples 14-16 to comparative example 5, it is found that adding strong acid after the reaction is completed such that pH is lowered to be close to neutral or acidic at certain degree (e.g., pH=3.5) could achieve better effect than the case in which no strong acid is added, namely lower Dn content.

Comparing examples 17 and 18 to examples 14-16, it is found that the reduction in pH is not lower the better. pH of greater than or equal to 4 could achieve better effect than the case in which pH is lower, namely lower Dn content. Thus, it is believed that pH of greater than or equal to 4 is a preferred pH range when strong acid is added after the reaction is completed, and a more preferred pH range is from 4 to 6.

1. A polysiloxane polymer composition, wherein said polysiloxane polymer composition is a product obtained from a process comprising the following steps:
reaction of hydrophobic component (a) comprising polysiloxane backbone and quaternization component (b) comprising tertiary amine group in the presence of protonation component (p);
wherein the protonation component (p) comprises at least one protonation compound (c) having a pKa of greater than 3.0 and at least one protonation compound (d) having a pKa of no greater than 3.0, preferably no greater than 2.5, preferably no greater than 2.0, more preferably no greater than 1.5, most preferably no greater than 1.0, and wherein the molar ratio between all protonation compound (c) and all protonation compound (d) (ΣMol_{protonation compound (c)}/ΣMol_{protonation compound (d)}) ranges from 9:1 to 0.1:1, preferably from 9:1 to 0.2:1, more preferably from 5:1 to 0.2:1, even more preferably from 2:1 to 0.2:1, most preferably from 2:1 to 0.4:1, still more preferably from 2:1 to 1:1;
wherein said polysiloxane polymer comprises following repeating unit: 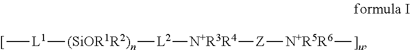
wherein u is from 2 to 100; L¹ and L² are the same or different, and are chosen from a covalent bond and a hydrocarbon chain having 1-20 carbon atoms optionally substituted with O, N or S atom, or substituted with groups containing O, N or S atom; R¹ and R² are the same or different and are chosen from an optionally substituted hydrocarbon chain having 1-20 carbon atoms, preferably methyl group, n is from 1 to 1000, preferably from 20 to 500, preferably from 40 to 450, more preferably from 50 to 200, even more preferably from 50 to 150; and
Z is a hydrocarbon chain containing 2-20 carbon atoms and optionally substituted with O, N or S atom, or substituted with groups containing O, N or S atom, preferably with OH group; R³, R⁴, R⁵ and R⁶ are the same or different and chosen from a hydrocarbon chain containing 1-20 carbon atoms, or, said polysiloxane polymer comprises of repeating unit of formula I′: 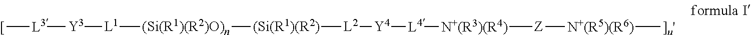
wherein n, u, L¹, L², R¹, R², R³, R⁴, R⁵, R⁶ and Z are defined as above,
Y³ and Y⁴ are the same or different and are respectively each independently chosen from O, N(R⁷) or S, R⁷═H or C₁-C₃ hydrocarbon group, for example C₁-C₃ alkyl group;
L^{3′} and L^{4′} are the same or different, and are chosen from covalent bond and hydrocarbon chain substituted by group(s) containing O, N or S atom, preferably OH, NH₂ or SH, and having 2-20 carbon atoms, preferably alkylene group having 2-6 carbon atoms, more preferably alkylene group having 3-4 carbon atoms; in particular, said OH, NH₂ or SH is derived from the ring opening reaction of oxygen heterocyclic ring having single oxygen atom, nitrogen heterocyclic ring having single nitrogen atom or sulfur heterocyclic ring having single sulfur atom (for example epoxy, aziridinyl or thioepoxy group) located at the end of the corresponding alkylene group of said hydrophobic component (a);
preferably, L¹ and L² are the same or different, and are respectively each independently chosen from alkylene group having 1-6 carbon atoms, in particular having 2, 3, 4 or 5 carbon atoms;
preferably, R³, R⁴, R⁵ and R⁶ each are independently alkyl group and Z is alkylene group, more preferably Z is a linear alkylene group comprising 2-8 carbon atoms for example butylene or hexylidene, and R³, R⁴, R⁵ and R⁶ are the same or different and are respectively each independently chosen from alkyl group containing 1-4 carbon atoms, for example R³, R⁴, R⁵ and R⁶ are all methyl groups;
said polysiloxane polymer composition also comprises counterions.

2. A polysiloxane polymer composition, wherein said polysiloxane polymer composition is a product obtained from a process comprising the following steps:
reaction of hydrophobic component (a) comprising polysiloxane backbone and quaternization component (b) comprising tertiary amine group in the presence of protonation component (p);
protonation component (p) comprises at least one protonation compound (c) having a pKa of greater than 3.0, and
protonation compound (d) is used during said reaction,
protonation compound (d) is added after said reaction, or
protonation compound (d) is used during said reaction and added after said reaction;
protonation compound (d) having a pKa of no greater than 3.0, preferably no greater than 2.5, preferably no greater than 2.0, more preferably no greater than 1.5, most preferably no greater than 1.0;
wherein said polysiloxane polymer comprises following repeating unit: 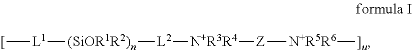
wherein u is from 2 to 100; L¹ and L² are the same or different, and are chosen from a covalent bond and a hydrocarbon chain having 1-20 carbon atoms optionally substituted with O, N or S atom, or substituted with groups containing O, N or S atom; R¹ and R² are the same or different and are chosen from an optionally substituted hydrocarbon chain having 1-20 carbon atoms, preferably methyl group, n is from 1 to 1000, preferably from 20 to 500, preferably from 40 to 450, more preferably from 50 to 200, even more preferably from 50 to 150; and
Z is a hydrocarbon chain containing 2-20 carbon atoms and optionally substituted with O, N or S atom, or substituted with groups containing O, N or S atom, preferably with OH group; R³, R⁴, R⁵ and R⁶ are the same or different and chosen from a hydrocarbon chain containing 1-20 carbon atoms, or, said polysiloxane polymer comprises of repeating unit of formula I′: 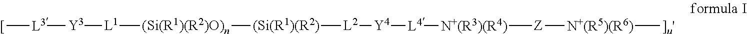
wherein n, u, L¹, L², R¹, R², R³, R⁴, R⁵, R⁶ and Z are defined as above,
Y³ and Y⁴ are the same or different and are respectively each independently chosen from O, N(R⁷) or S, R⁷═H or C₁-C₃ hydrocarbon group, for example C₁-C₃ alkyl group;
L^{3′} and L^{4′} are the same or different, and are chosen from covalent bond and hydrocarbon chain substituted by group(s) containing O, N or S atom, preferably OH, NH₂ or SH, and having 2-20 carbon atoms, preferably alkylene group having 2-6 carbon atoms, more preferably alkylene group having 3-4 carbon atoms; in particular, said OH, NH₂ or SH is derived from the ring opening reaction of oxygen heterocyclic ring having single oxygen atom, nitrogen heterocyclic ring having single nitrogen atom or sulfur heterocyclic ring having single sulfur atom (for example epoxy, aziridinyl or thioepoxy group) located at the end of the corresponding alkylene group of said hydrophobic component (a);
preferably, L¹ and L² are the same or different, and are respectively each independently chosen from alkylene group having 1-6 carbon atoms, in particular having 2, 3, 4 or 5 carbon atoms;
preferably, R³, R⁴, R⁵ and R⁶ each are independently alkyl group and Z is alkylene group, more preferably Z is a linear alkylene group comprising 2-8 carbon atoms for example butylene or hexylidene, and R³, R⁴, R⁵ and R⁶ are the same or different and are respectively each independently chosen from alkyl group containing 1-4 carbon atoms, for example R³, R⁴, R⁵ and R⁶ are all methyl groups;
said polysiloxane polymer composition also comprises counterions.

3. The polysiloxane polymer composition according to claim 1, wherein polysiloxane polymer further comprises repeating unit of formula II [-L¹-(SiOR¹R²)ₙ-L²-Y^{1′}-E-Y^{2′}]ᵥ,
wherein v is from 1 to 100, E is a covalent bond or a polyether moiety comprising one or more of the following repeating unit: -(ethylene oxide)ₓ-, -(propylene oxide)_{y}- or -(butylene oxide)_{z}-, x, y and z are the same or different, and
x=0 or 1-100, preferably 1-20, more preferably 1-10, even more preferably 1-5, most preferably 1, 2 and 3,
y=0 or 1-100, preferably 1-20, more preferably 1-10, even more preferably 1-5, most preferably 1, 2 and 3,
z=0 or 1-100, preferably 1-20, more preferably 1-10, even more preferably 1-5, most preferably 1, 2 and 3,
x+y+z=0-100, preferably 0 and 1-100, more preferably 1-20, even more preferably 1-10, most preferably 0, 1, 2, 3;
Y^{1′} and Y^{2′} comprise functional groups independently chosen from nitrogen-containing groups, oxygen-containing groups or sulfur-containing groups, preferably amine-containing groups, hydroxyl-containing groups or thiol-containing groups, more preferably amine-containing groups, most preferably secondary amine-containing, tertiary amine-containing groups, amine salts derived from secondary or tertiary amine containing groups, or quaternary ammonium-containing groups, at least one of Y^{1′} and Y^{2′} optionally contains hydrocarbon groups connecting their functional groups to E or to the other one of Y^{1′} and Y^{2′} and containing 1-20 carbon atoms,
or, polysiloxane polymer further comprises repeating unit of formula II′: 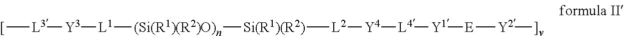
wherein n, v, L¹, L², R¹, R², E, Y^{1′}, Y^{2′}, L^{3′}, Y³, Y⁴ and L^{4′} are defined as above,
preferably, at least one of Y^{1′} and Y^{2′} optionally contains hydrocarbon group connecting the above-mentioned functional group to E or to the other one of Y^{1′} and Y^{2′} and containing 1-20 carbon atoms, in particular alkylene group, for example linear or branched alkylene group containing 1-6 or 1-3 carbon atoms, and at least one of the above-mentioned functional group is optionally directly connected to E by covalent bond.

4. The polysiloxane polymer composition according to claim 1, wherein the hydrophobic component (a) contains a structure of formula III: 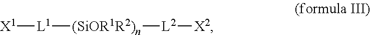
wherein L¹ and L² are the same or different and are chosen from a covalent bond and a hydrocarbon chain having 1-20 carbon atoms optionally substituted with O, N or S atom, or substituted with groups containing O, N or S atom; X¹ and X² groups are the same or different and are chosen from H, epoxy group or hydroxyl group, or derived from ethylene oxide, propylene oxide or butylene oxide, and when L¹ and L² are covalent bonds, X¹ and X² groups are H; R¹ and R² are the same or different and are chosen from an optionally substituted hydrocarbon chain containing 1-20 carbon atoms, preferably methyl group, n is from 1 to 1000, preferably from 20 to 500, preferably from 40 to 450, more preferably from 50 to 200, even more preferably from 50 to 150,
or, the hydrophobic component (a) contains a structure of formula III′: 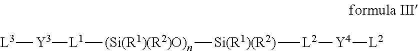
wherein, n, L¹, L², R¹, R², Y³ and Y⁴ are defined as above, L³ and L⁴ are the same or different and are hydrocarbon chain comprising oxygen heterocyclic ring having single oxygen atom, nitrogen heterocyclic ring having single nitrogen atom or sulfur heterocyclic ring having single sulfur atom (for example epoxy, aziridinyl or thioepoxy group), preferably oxygen heterocyclic ring having single oxygen atom, nitrogen heterocyclic ring having single nitrogen atom or sulfur heterocyclic ring having single sulfur atom (for example epoxy, aziridinyl or thioepoxy group) of from 3 to 5 membered ring and having 2-20 carbon atoms, preferably alkylene group having 2-6 carbon atoms, more preferably alkylene group having 3-4 carbon atoms; in particular, said oxygen heterocyclic ring having single oxygen atom, nitrogen heterocyclic ring having single nitrogen atom or sulfur heterocyclic ring having single sulfur atom (for example epoxy, aziridinyl or thioepoxy group) is located at the end of said alkylene group.

5. The polysiloxane polymer composition according to claim 1, wherein the quaternization component (b) contains a structure of formula IV: 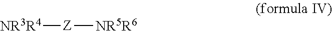
wherein Z is a linear, branched, or cyclic hydrocarbon moiety containing 2-20 carbon atoms and optionally substituted with O, N or S atom, or substituted with groups containing O, N or S atom, preferably with OH group; R³, R⁴, R⁵ and R⁶ are the same or different and are chosen from a hydrocarbon group containing 1-20 carbon atoms,
or, the quaternization component (b) contains structure of formula IV′: 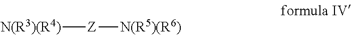
wherein, R³, R⁴, R⁵, R⁶ and Z are defined as above;
preferably, R³, R⁴, R⁵ and R⁶ each are independently alkyl group and Z is alkylene group, more preferably Z is a linear alkylene group comprising 2-8 carbon atoms for example butylene or hexylidene, and R³, R⁴, R⁵ and R⁶ are the same or different and are respectively each independently chosen from alkyl group containing 1-4 carbon atoms, for example R³, R⁴, R⁵ and R⁶ are all methyl groups.

6. The polysiloxane polymer composition according to claim 1, wherein the hydrophilic component (e) is also present in said reaction, and hydrophilic component (e) contains a structure of formula V: 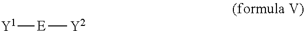
wherein the meaning of E is as defined in claim 3; Y¹ and Y² comprise functional groups independently chosen from nitrogen-containing groups, oxygen-containing groups or sulfur-containing groups, preferably amine-containing groups, hydroxyl-containing groups or thiol-containing groups, more preferably amine-containing groups, most preferably primary amine-containing or secondary amine-containing groups, at least one of Y¹ and Y² optionally contains hydrocarbon groups connecting their functional groups to E or to the other one of Y¹ and Y² and containing 1-20 carbon atoms,
or, the hydrophilic component (e) contains structure of formula V′: 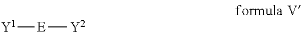
wherein Y¹, Y² and E are defined as above,
preferably, at least one of Y¹ and Y² optionally contains a hydrocarbon group connecting the above-mentioned functional group to E or to the other one of Y¹ and Y² and containing 1-20 carbon atoms, in particular alkylene group, for example linear or branched alkylene group containing 1-6 or 1-3 carbon atoms, and at least one of the above-mentioned functional group is optionally directly connected to E by covalent bond.

7. The polysiloxane polymer composition according to claim 1, wherein the protonation compound (c) comprises one or more of:
linear or branched, saturated and unsaturated, optionally —O— containing or —OH substituted C₂-C₃₀ carboxylic acid, preferably ether group-containing carboxylic acid, which has a structure of R^{e}—O-(EO)ₚ—CH₂COOH, wherein p=1-100 and R^{e} is an optionally substituted hydrocarbon group containing 1-20 carbon atoms, preferably alkyl group;
linear or branched C₁₈-C₂₀₀ polymeric fatty acids,
preferably polymeric fatty acids of the following type: 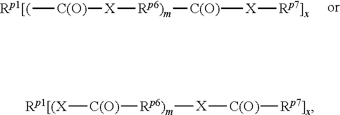
wherein either R^{p1} or at least one of R^{p7}, or both R^{p1} and at least one of R^{p7} bear one ore more of carboxylic group,
in particular,
linear polymeric fatty acids of the type 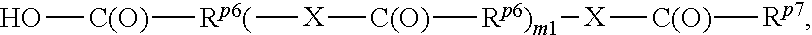
more particularly HO—C(O)—R^{p6}—(O—C(O)—R^{p6})ₘ—O—C(O)—R^{p7},
branched linear polymeric fatty acids, in particular branched linear polymeric fatty acid carboxylates derived from partial esters of polyfunctional carboxylic acids, in particular of the dicarboxylic acids succinic acid and maleic acid, with castor oil or lesquerella oil, such as on 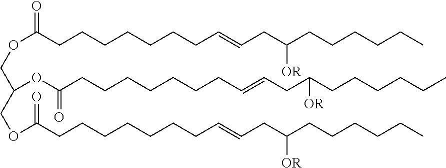
wherein one R in the above formula is 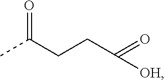
and the remaining two R groups are 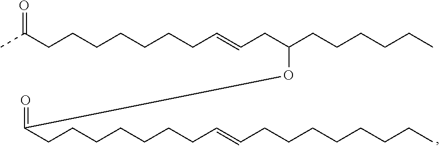
dendritic polymeric fatty acids
or preferably polymeric fatty acids of the following type: 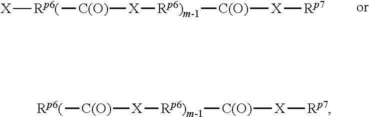
wherein in the two latter types the R^{p7} group bears at least one carboxylic group,
or preferably polymeric fatty acids of the following type: 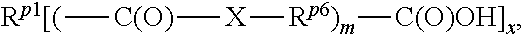
in the structures of the above polymeric fatty acids, independently from one another,
x=1-50, m=1-20, X═O or NR^{p11}, preferably X═O,
R^{p1} is chosen from x-valent, optionally substituted hydrocarbon group which has up to 1000 carbon atoms, preferably 2-300 carbon atoms, more preferably 3-200 carbon atoms, even more preferably 3-150 carbon atoms, in particular 3-50 carbon atoms, more particularly 3-20 carbon atoms, and optionally contains one or more groups chosen from: —O—, —NH—, —C(O)—, —C(S)—, tertiary amino groups 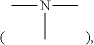
and is optionally substituted by one or more groups selected from OH groups and halide groups;
R^{p6} is independently chosen from optionally substituted straight-chain, cyclic or branched, saturated or unsaturated hydrocarbon group which has 1-36 carbon atoms, preferred 1-24 carbon atoms, more preferred 1-18 carbon atoms, even more preferred 8-18 carbon atoms;
R^{p7} is independently chosen from optionally substituted straight-chain, cyclic or branched, saturated or unsaturated hydrocarbon group which has 1-36 carbon atoms, preferred 1-24 carbon atoms, more preferred 1-18 carbon atoms, even more preferred 8-18 carbon atoms, optionally containing one or more groups chosen from: —O—, —NH—, —C(O)—, —C(S)—, tertiary amino groups 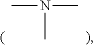
quaternary ammonium group 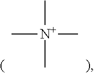
and which is optionally substituted with OH groups or halide groups, wherein R^{p7} group does not contain a combination of a —C(O)— group and a —O— group or a combination of a —C(O)— group and a —NH— or tertiary amino group forming an internal carboxylate group or an internal amide group; with the proviso that at least one R^{p6} has more than 6 carbon atoms;
R^{p11} independently chosen from hydrogen, optionally substituted straight-chain, cyclic or branched, saturated, unsaturated or aromatic hydrocarbon group which has up to 100 carbon atoms, which optionally contains one or more groups chosen from —O—, —NH—, —C(O)—, —C(S)—, tertiary amino groups 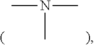
and is optionally substituted with one or more hydroxyl and halide groups;
or preferably polymeric fatty acids of the following type: 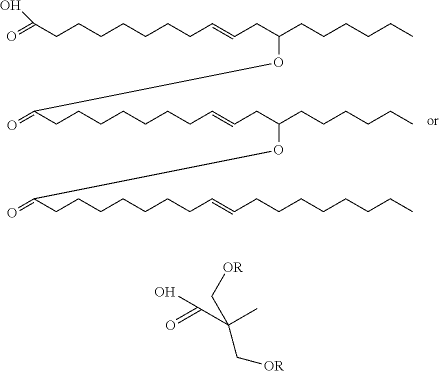
R in the above formula is 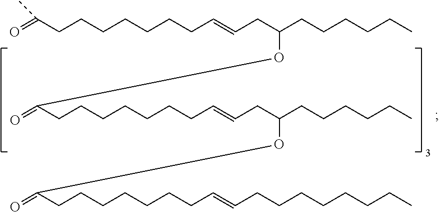
preferably, protonation compound (c) comprises one or more chosen from: acidic amino acid, for example aspartic acid and glutamic acid, lactic acid, 2-ethyl-hexanoic acid, dodecanoic acid, hexadecanoic acid, octadecanoic acid, oleic acid, ricinoleic acid, 12-hydroxy-octadecanoic acid, succinic acid, maleic acid, tartaric acid, polyethercarboxylic acid, citric acid, acetic acid, propionic acid, butyric acid, valeric acid, caproic acid, heptanoic acid, octanoic acid, nonanoic acid, capric acid, undecanoic acid and lauric acid.

8. The polysiloxane polymer composition according to claim 1, wherein the protonation compound (d) comprises one or more chosen from the following: acids containing sulfonate group, preferably sulfonic acid substituted with alkyl or aryl group, hydrohalic acid, oxy acids of from V to VI main group elements, acids containing sulfate group, acids containing phosphate group or phosphonate group, carboxylic acid containing 2-20 carbon atoms;
preferably, protonation compound (d) comprises one or more chosen from the following: phosphoric acid, sulfamic acid optionally containing substitution group, methyl sulfamic acid, HCl, methanesulfonic acid, ethanesulfonic acid, benzenesulfonic acid, dodecylbenzenesulfonic acid, sulfuric acid, bisulfate salt, phosphonic acid, aminophosphonic acid or aminocarboxylic acid.

9. The polysiloxane polymer composition according to claim 1, wherein the contents by weight of the components in said reaction relative to the sum of the contents by weight of the components are:
the hydrophobic component (a), 50-95%, preferably 60%-90%, more preferably 70-90%,
the quaternization component (b), 0.1-10%, preferably 0.3-7%, more preferably 0.5-5%,
optional hydrophilic component (e), 0%, or 0.1-10%, preferably 0.3-7%, more preferably 0.5-5%,
the protonation component (p), 0.1%-20%, preferably 0.5-15%, more preferably 1-10%, and
optional reaction medium (f), 0%, or 1-60%, preferably 5-50%, more preferably 10-40%, most preferably reaction medium (f) is consisted of 5-20% of dipropylene glycol n-butyl ether and 5-20% of water,
with the proviso that the sum of the contents by weight of the above components do not exceed 100%.

10. The polysiloxane polymer composition according to claim 1, wherein said polysiloxane polymer composition is acidic, preferably having a pH of from 2 to less than 7, more preferably a pH of from 2 to 6, still more preferably a pH of from 3 to 6, still more preferably a pH of from 4 to 6, most preferably a pH of from 4 to 5.5, in which the pH is measured as follows, pH value is measured after the polysiloxane polymer composition is diluted with mixed solvent in 1:10 weight ratio to 10% in concentration, the mixed solvent is a mixed solvent of isopropanol and water in volume ratio of 5:3,
in particular, in case that the protonation compound (d) is used after the reaction is completed, the pH value is the result of the addition of the protonation compound (d); more particularly, the pH of said polysiloxane polymer composition is from 4.2 to 6, from 4.4 to 6 or from 4.6 to 6, or the pH of said polysiloxane polymer composition is from 4.2 to 5.5, or from 4.4 to 5.5 or from 4.6 to 5.5 or from 4.6 to 5.7.

11. The polysiloxane polymer composition according to claim 1, wherein the molar ratio of the protonation component (p) relative to the tertiary amine group in the quaternization component (b) is under stoichiometric, stoichiometric or higher, preferably the molar ratio of protonation component (p) relative to the tertiary amine group in the quaternization component (b) is no greater than 0.5, 0.7, 0.9, 1.0, 1.2, 1.4, 1.5, 2, 3 or 4 times of the stoichiometric ratio, preferably the molar ratio of protonation compound (p) relative to the tertiary amine group in the quaternization component (b) is 0.5 to 4:1, more preferred 0.5 to 2:1, 0.7 to 2:1 or 0.9 to 2:1, even more preferred 0.5 to <1:1, 1:1, >1 to 2:1, most preferred >1 to 1.5:1, >1 to 1.4:1 or >1 to 1.2:1.

12. The polysiloxane polymer composition according to claim 1, wherein said reaction is carried out in the presence of a reaction medium (f), preferably including polar solvent and non-polar solvent, the polar solvent preferably chosen from water, alcohols, ethers, esters and glycols, the non-polar solvent preferably chosen from saturated, unsaturated or aromatic hydrocarbons, for example toluene and xylene, preferably, the reaction medium (f) comprises a mixture of water and alcohols or a mixture of water and ethers, in particular a mixture of water and 2-propanol or a mixture of water and dipropylene glycol n-butyl ether, preferably, the mass ratio between dipropylene glycol n-butyl ether and water is from 0.5:1 to 10:1, or 0.7:1 to 7:1, or from 1:1 to 5:1.

13. The polysiloxane polymer composition according to claim 1, wherein the molar ratio between the repeating unit of formula I and the repeating unit of formula II is from 0.1 to 4, or from 1 to 4, or from 2 to 3.

14. The polysiloxane polymer composition according to claim 1, wherein the molar ratio between hydrophobic component (a) and quaternization component (b) is from 1 to 10, or from 2 to 9, or from 3 to 8, or from 4 to 7, or from 5 to 6.

15. The polysiloxane polymer composition according to claim 1, wherein the molar ratio between hydrophilic component (e) and quaternization component (b) is from 0.05 to 0.9, or from 0.1 to 0.8, or from 0.2 to 0.7, or from 0.3 to 0.6, or from 0.4 to 0.5.

16. The polysiloxane polymer composition according to claim 1, wherein in order to obtain said polysiloxane polymer composition, there is a step of adding protonation compound (d) after the reaction.

17. The polysiloxane polymer composition according to claim 1, wherein in order to obtain said polysiloxane polymer composition, no protonation compound (d) is added after the reaction.

18. The polysiloxane polymer composition according to claim 2, wherein said reaction for obtaining said polysiloxane polymer composition is carried out in the presence of protonation compound (d).

19. The polysiloxane polymer composition according to claim 2, wherein said reaction for obtaining said polysiloxane polymer composition is carried out without protonation compound (d).

20. The polysiloxane polymer composition according to claim 2, wherein during the reaction, the protonation component (p) comprises at least one protonation compound (c) having a pKa of greater than 3.0 and at least one protonation compound (d) having a pKa of no greater than 3.0, preferably no greater than 2.5, preferably no greater than 2.0, more preferably no greater than 1.5, most preferably no greater than 1.0, and wherein the molar ratio during the reaction between all protonation compound (c) and all protonation compound (d) (ΣMol_{protonation compound (c)}/ΣMol_{protonation compound (d)}) ranges from 9:1 to 0.1:1, preferably from 9:1 to 0.2:1, more preferably from 5:1 to 0.2:1, even more preferably from 2:1 to 0.2:1, most preferably from 2:1 to 0.4:1, still more preferably from 2:1 to 1:1.

21. The polysiloxane polymer composition according to claim 19, wherein the molar ratio between all protonation compound (c) and all protonation compound (d) is from 1:0.2 to 1:1.

22. The polysiloxane polymer composition according to claim 16, wherein the molar ratio between the sum of protonation compound (c) and the protonation compound (d) used during the reaction and the protonation compound (d) added after the reaction is from 1:0.1 to 1:1, preferably from 1:0.2 to 1:1, more preferably from 1:0.2 to 1:0.8, even more preferably from 1:0.2 to 1:0.6, most preferably from 1:02 to 1:0.4.

23. The polysiloxane polymer composition according to claim 1, wherein the pKa of the protonation compound (d) is no greater than 2.5 and the pKa of the protonation compound (c) is greater than 2.5, or the pKa of the protonation compound (d) is no greater than 2.0 and the pKa of the protonation compound (c) is greater than 2.0.

24. A method for preparing the polysiloxane polymer composition according to claim 1, wherein said method comprises:
reaction of hydrophobic component (a) comprising polysiloxane backbone and quaternization component (b) comprising tertiary amine group in the presence of protonation component (p);
wherein the protonation component (p) comprises at least one protonation compound (c) having a pKa of greater than 3.0 and at least one protonation compound (d) having a pKa of no greater than 3.0, preferably no greater than 2.5, preferably no greater than 2.0, more preferably no greater than 1.5, most preferably no greater than 1.0, and wherein the molar ratio between protonation compound (c) and protonation compound (d) ranges from 9:1 to 0.1:1, preferably from 9:1 to 0.2:1, more preferably from 5:1 to 0.2:1, even more preferably from 2:1 to 0.2:1, most preferably from 2:1 to 0.4:1, still more preferably from 2:1 to 1:1.

25. The method according to claim 24, wherein in order to obtain said polysiloxane polymer composition, there is a step of adding protonation compound (d) after the reaction.

26. The method according to claim 24, wherein in order to obtain said polysiloxane polymer composition, no protonation compound (d) is added after the reaction.

27. A method for preparing the polysiloxane polymer composition according to claim 2, wherein said method comprises:
reaction of hydrophobic component (a) comprising polysiloxane backbone and quaternization component (b) comprising tertiary amine group in the presence of protonation component (p);
protonation component (p) comprises at least one protonation compound (c) having a pKa of greater than 3.0;
addition after said reaction of protonation compound (d) having a pKa of no greater than 3.0, preferably no greater than 2.5, preferably no greater than 2.0, more preferably no greater than 1.5, most preferably no greater than 1.0.

28. The method according to claim 27, wherein said reaction for obtaining said polysiloxane polymer composition is carried out in the presence of protonation compound (d).

29. The method according to claim 27, wherein said reaction for obtaining said polysiloxane polymer composition is carried out without protonation compound (d).

30. A method comprising the use of the polysiloxane polymer composition according to claim 1 in the field of fiber, textile, cosmetics or personal care.
